(19) United States
(12) Patent Application Publication
(10) Pub. No.: US 2010/0067116 A1
(43) Pub. Date: Mar. 18, 2010

(54) FILTER OF DISPLAY DEVICE

(76) Inventors: Yeon Keun Lee, Daejeon (KR); Hyun Seok Choi, Daejeon (KR); Jung Doo Kim, Daejeon (KR); Sang Hyun Park, Daejeon (KR); Su Rim Lee, Daejeon (KR)

Correspondence Address: MCKENNA LONG & ALDRIDGE LLP, 1900 K STREET, NW, WASHINGTON, DC, 20006, US

(21) Appl. No.: 12/448,554

(22) PCT Filed: Apr. 7, 2008
(86) PCT No.: PCT/KR2008/001950

§ 371 Date: Jun. 25, 2009

(30) Foreign Application Priority Data
Apr. 6, 2007 (KR) 10-2007-0034408

(51) Int. Cl. G02B 5/20

(52) U.S. Cl. 359/613

(57) ABSTRACT

There is provided a filter of a display device capable of ensure a contrast ratio equal to or more than a predetermined value in various viewing angles. The filter of a display device includes a transparent film; and a plurality of stripe patterns formed parallel to both surfaces of the transparent film, wherein a width (a) of the stripe patterns and a thickness (t) of the transparent film are adjusted to a critical angle (θc) of 20 to 50°.

### TECHNICAL FIELD

The present invention relates to a filter of a display device, and more particularly, to a filter of a display device capable of ensuring a contrast ratio equal to or more than a predetermined value in various viewing angles.

### BACKGROUND ART

A PDP display device displays an image by inducing gas discharge between electrodes and exciting phosphors in desired pixels through the emission of ultraviolet rays formed by the gas discharge.

Various kinds of electromagnetic waves and near infrared rays are emitted due to the above-mentioned characteristics of the PDP device. However, the electromagnetic waves and the near infrared rays are harmful to human body, and also cause problems of inducing an erroneous operation of other surrounding electronic equipment, and therefore a filter is attached to a surface of the PDP device to cut off the electro-magnetic waves and the near infrared rays. The filter includes an electromagnetic wave shielding film or a near infrared ray shielding film to cut off the absorption of the electromagnetic waves within a near infrared ray region.

However, the PDP filters are generally transparent since the light emitted through the filter from PDP should be transmitted to an observer.

In the meantime, the light is emitted through the filter from the PDP display device to the external environment and external light may also be inversely introduced into the display device through the PDP filter under a bright room condition such as daylight or environments illuminated with strong light. This external light is reflected on a PDP panel and reaches an observer while the external light is overlapped with the light emitted from the PDP panel. Hereinafter, the reflected and emitted external light is referred to as a reflective light.

A contrast ratio of an image may be seriously deteriorated when the reflective light that enters the display device through the PDP filter is emitted with the reflective light being overlapped with the light emitted from the PDP panel as described above. The contrast ratio is referred to as a ratio of the brightest image to the darkest image that may be displayed on a display device. Considering only the light emitted from the PDP panel (a complete dark room condition), the contrast ratio is represented by the following Equation 1.

$$contrast ratio ( dark room condition ) = \frac{brightness of white light}{brightness of black light} \qquad Equation 1$$

Meanwhile, the equation is slightly different when the reflective light is emitted with the white light and the black light at a bright room condition as described above. That is to say, since the reflective light is reflected at the same brightness level regardless of the white light and the black light, the brightness of the pixels displaying a white light and a black light is increased as much as the increase in the brightness of each of the reflective lights. As a result, the contrast ratio is represented by the following Equation 2.

$$contrast ratio ( dark room condition ) = \frac{\begin{matrix}brightness of white light + \\ brightness of reflected light\end{matrix}}{\begin{matrix}brightness of black light + \\ brightness of reflected light\end{matrix}} \qquad Equation 2$$

The contrast ratio represented by the Equation 1 has a value more than 1 since the white light has a higher brightness than the black light. In this condition, the contrast ratio is diminished as the brightness of the reflective light is added to a denominator. Therefore, even the same display device has highly different contrast ratio in the dark room condition and the bright room condition.

Among various display devices, LCD is characterized in that there is hardly a reflective light since the LCD display device absorbs all of external light when the external light enters the LCD display device. However, CRT or PDP is affected by the reflective light when it is used under a bright circumstance, which leads to the highly diminished contrast ratio.

For the above-mentioned context, the contrast ratio of the PDP display device in the external light-free dark room condition is very excellent with a contrast value of greater than 1000 since the black light of the PDP display device generally has a brightness (luminance) of about 1 cd/m² or less and the white light has a brightness of 1000 cd/m² or more.

However, the contrast ratio of PDP is highly affected by the brightness of the reflective light under an external light-existing condition, that is, a bright room condition as described above, and therefore it is necessary to determine what extent the brightness of the reflective light is so as to approximately estimate how much the brightness of the reflective light affects the contrast ratio of PDP.

The reflective light enters the field of vision of an observer through the process in which external light enters a display device, and then is reflected on a surface of the display device. Therefore, it might be seen that the brightness of the reflective light is proportional to the brightness (IL_{PDP}) of the external light which illuminates a PDP display device, and also proportional to the reflection level (R_{PDP}) of the external light that is reflected on a surface or the inner part (phosphor) of the PDP. Therefore, the brightness of the reflective light may be represented by a proportional equation such as the following Equation 3.

Brightness of Reflective Light∝IL_{PDP}·R_{PDP} Equation 3

In this case, the brightness of the external light which illuminates the PDP display device may be measured as a function of illumination intensity (1×) at the PDP surface, a conversion constant should be selected to express the equation rather than the proportional equation, the conversion constant being used to convert the brightness of the white light or the black light emitted from the display device into a brightness unit cd/m² that is identical to the brightness of the white light or the black light. Here, it is difficult to converts the brightness of the white light or the black light into the completely identical brightness value, but it has been known that the equation ┌11×=1/π·d/m²┘ is satisfied under an ideal condition (1 lux of illuminance on a perfectly diffusing surface produces 1 apostilb (1/π·d/m²) of luminance). Therefore, the Equation 3 may be represented by the following Equation 4.

Brightness of Reflective Light=IL_{PDP}R_{PDP}·1/π Equation 4

The following Equation 5 may be obtained by substituting the results of Equation 4 into the Equation 2.

$$contrast ratio ( bright room condition ) = \frac{\begin{matrix}brightness of white light + \\ {IL}_{PDP} \cdot {R}_{PDP} \cdot \frac{1}{π}\end{matrix}}{\begin{matrix}brightness of black light + \\ {IL}_{PDP} \cdot {R}_{PDP} \cdot \frac{1}{π}\end{matrix}} \qquad Equation 5$$

Reflectance (R_{PDP}) showing the extent to which a reflective light is reflected on a PDP surface has been known to be about 20 to 30%. Assume that the PDP surface has a reflectance of 30% and an illumination intensity of 1001× in relation to the external lighting, and the brightness of the reflective light represented by the Equation 4 is about 9.5 cd/m², and thus the contrast ratio that was greater than 1000 under the dark room condition is diminished by about 100 under the bright room condition when substituted into to the Equation 5. That is to say, contrast ratios of the dark room condition and the bright room condition in the conventional PDP display device are different about 10 times to each other, which is very important in aspect of the discrimination of images.

Although there may be a difference, this phenomenon may be experienced in the display device, such as a screen for front projection TV, a CRT screen or the like, whose screen has high reflectance.

Therefore, there have been various attempts to improve a contrast in the bright room condition. The various attempts have started to check degradation in the contrast ratio. As seen from the Equation 2 or 5, it is revealed that the degradation in the contrast ratio at the bright room condition is determined by the brightness of the reflective light that is generated when external light is reflected on a surface of the display device, and thus depends on the reflectance (R_{PDP}) when it is assumed that the brightness of the external light, which is one of factors determining brightness of the reflective light, is not adjusted to a predetermined brightness level.

This reflectance results from a phenomenon in which the incident light is re-reflected by a phosphor having high reflectance since the phosphor is present in a surface of the PDP panel. That is to say, various layers such as films or substrates are present in a surface of the PDP display device, but it is confirmed that most of the light is reflected by the phosphor that is present in the surface of the PDP panel.

One of techniques, which are generally used to reduce a level of reflectance where the external light is reflected on the display device, is to reduce brightness of the light that is reflected out with using the filter attached to a surface of the PDP display device. That is to say, when a PDP filter having a constant transmittance (T_{filter}) is attached to a surface of a display device, the external light is passed through a filter and then reflected by a phosphor that is present in a surface of a PDP panel, unlike the conventional display devices in which the external light is directly reflected on a surface thereof. Then, the external light is passed through the filter again to finally reach the field of vision of an observer. Therefore, the external light is subject to two filtering operations until the external light is reflected to reach the field of vision of an observer. Here, since the brightness of the light reached through one filtering operation is diminished as much as the transmittance (T_{filter}), the reflective light undergoing two transmission operations has a brightness value (cd/m²) represented by the following Equation 6.

Brightness of Reflective Light=IL_{PDP}·R_{PDP}·1/π·T_{filter}² Equation 6

Also, a drop of brightness level of the light emitted from the PDP display device is not higher than that of the external light undergoing the two filtering operations. However, since the light emitted from the display device is also compulsorily subject to one filtering operation, the brightness of the light is diminished as much as T_{filter}. Therefore, when a filter whose transmittance (T_{filter}) is controlled to a constant transmittance level is arranged in the front of the display device so as to improve its contrast, the contrast ratio of the PDP display device represented by the Equation 5 is represented by the following Equation 7.

$$contrast ratio ( bright room condition ) = \frac{\begin{matrix}brightness of white light \cdot {T}_{filter} + \\ {IL}_{PDP} \cdot {R}_{PDP} \cdot \frac{1}{π} \cdot {T}_{filter}^{2}\end{matrix}}{\begin{matrix}brightness of black light \cdot {T}_{filter +} \\ {IL}_{PDP} \cdot {R}_{PDP} \cdot \frac{1}{π} \cdot {T}_{filter}^{2}\end{matrix}} \qquad Equation 7$$

In the Equation, the relation of the following Equation 8 may be satisfied when the variable ‘T_{filter}’ is removed from the numerator and the denominator.

$$contrast ratio ( bright room condition ) = \frac{\begin{matrix}brightness of white light + \\ {IL}_{PDP} \cdot {R}_{PDP} \cdot \frac{1}{π} \cdot {T}_{filter}\end{matrix}}{\begin{matrix}brightness of black light + \\ {IL}_{PDP} \cdot {R}_{PDP} \cdot \frac{1}{π} \cdot {T}_{filter}\end{matrix}} \qquad Equation 8$$

In this case, when the term, IL_{PDP}.R_{PDP}·1/π·T_{filter}, is sufficiently bigger than the brightness of the black light, the brightness of the black light may be disregarded from the Equation 8, and therefore the Equation 8 is simply approximate to the following Equation 9.

$$contrast ratio ( bright room condition ) = \frac{brightness of white light}{{IL}_{PDP} \cdot {R}_{PDP} \cdot \frac{1}{π}} \cdot \frac{1}{{T}_{filter}} + 1 \qquad Equation 9$$

That is to say, as seen from the Equation 9, it is revealed that the contrast ratio of the display device is inversely proportional to the transmittance of the filter (a constant of 1 is expressed in the Equation, but the constant of 1 may be disregarded due to the very low value in relation to the conventional contrast ratio). Therefore, the contrast ratio of the display device may be improved when the transmittance of the filter is controlled to a very low transmittance level, that is, controlled so that it can be difficult for the light to penetrate the filter. However, there has been proposed a method capable of improving contrast ratio by controlling transmittance of the filter to a suitable transmittance level since the light emitted from the display device may also be cut off too much when the transmittance of the filter is diminished to infinity.

The above-mentioned filter has been referred to as an ND filter in the field of CRT in the art. The filter means a filter having transmittance that is reduced at the same rate in all of visible wavelength regions. A band pass filter that is further developed from the conventional ND filter has been used for PDP to improve its contrast ratio. This kind of the filter functions to improve a color purity of PDP by filtering the light within an unnecessary wavelength region using the slight difference in the transmittance in every wavelength. However, both of the ND filter and the band pass filter have almost similar physical properties in aspect of the contrast when they have the same transmittance. Therefore, an improved contrast level of the conventional PDP filter is predicted and evaluated using the conventional ND filter, and the results will then be described in detail. FIG. 1 shows that the contrast ratio is changed according to the transmittance of the ND filter and the illumination intensity of the PDP surface. FIG. 1 shows the results obtained when luminance of a white light is set to a luminance level of 1000 cd/m², luminance of a black light is set to a luminance level of 1 cd/m², and reflectance of a PDP panel is set to a reflectance level of 30%. From the results as shown in FIG. 1, it might be revealed that the contrast ratio is improved with decrease in the transmittance.

However, a filter for controlling optical transmittance, which is similar to the above-mentioned ND filter has limitation to control its contrast ratio. That is to say, the transmittance should be inevitably reduced to improve the contrast ratio as described previously. In this case, it is possible to improve the contrast ratio, but an image may be displayed darkly on a screen since it is difficult to pass even the light of the screen emitted from the display device.

As an alternative to solve the above problems, Korean Patent Publication No. 10-2006-0080116 discloses a filter for display apparatus including an external light shielding layer in the form of stripe so as to emit the light emitted from the display device at the maximum level and reduce the reflected external light to the minimum level. The filter for display device has the same configuration as shown in FIG. 2, and a light shielding pattern in the filter functions not to prevent the transmission of the light of a screen emitted toward the field of vision of an observer that is present in the front of the display device. This is done by cutting off a obliquely incident light when the external light enters the conventional display device obliquely from an upper side of the display device, but not by cutting off the light emitted from the front of the display device. In this case, the improved contrast ratio may be obtained and the sufficient brightness of a screen may also be ensured since the brightness of the reflective light represented by the Equation 2 or 5 is decreased but the brightness if the white light is not diminished in the display device. Therefore, it is possible to solve the prior-art problems.

However, as disclosed in the Korean Patent Publication No. 10-2006-0080116, the film having light shielding pattern formed therein has a problem that the characteristic of the upper and lower viewing angles may be deteriorated according to the position of an observer. As shown in FIG. 3, when the observer is positioned down at a constant angle from the display device or in an opposite direction, all the light emitted from the display device is cut off. As a result, the completely dark black image is observed. This is why the light shielding pattern is produced so that all the light can be cut off by continuing to diminish its transmittance with increase in the incidence angle of the light that is primarily entered at a oblique angle.

Also according to the Korean Patent Publication No. 10-2006-0080116, since the wedge pattern is farmed inside the film, a stripe pattern may be obtained in a complicated process including: forming a UV resin layer having wedge-patterned grooves, supplying a UV-thermosetting resin (containing carbon) to the formed grooves and curing the UV-thermosetting resin by illuminating the UV-thermosetting resin with ultraviolet rays. Therefore, the prior-art film has a problem that its manufacturing process is complicated.

### DISCLOSURE OF INVENTION

### Technical Problem

The present invention is designed to solve the problems of the prior art, and therefore it is an object of the present invention to provide a filter of a display device capable of being manufactured through a simple manufacturing process without any limitation on viewing angles.

Also, it is another object of the present invention to provide a display device including the filter.

### Technical Solution

According to an aspect of the present invention, there is provided a filter of a display device including a transparent film; and a plurality of stripe patterns formed parallelly on both surfaces of the transparent film, wherein

a width (a) of the stripe patterns and a thickness (t) of the transparent film are adjusted so that a critical angle (θ_{c}) may be 20 to 50° as represented by the following Equation:

$${θ}_{c} = arc sin ( {R}_{i} ( sin ( arc tan ( \frac{a}{t} ) ) ) \qquad Equation$$

wherein, Rᵢ represents a refractive index of the transparent film.

According to another aspect of the present invention, there is provided a filter of a display device including a transparent film; and a plurality of stripe patterns formed parallelly on both surfaces of the transparent film,

wherein an front opening ratio ranges from 50 to 80% when viewed from the front of the transparent film, as defined as a ratio of an area of the transparent film, which is not occupied by each of the stripe patterns when viewed from the front of the transparent film, to the entire area of the transparent film.

According to still another aspect of the present invention, there is provided a filter of a display device including a transparent film; and a plurality of stripe patterns formed parallelly on both surfaces of the transparent film, wherein a width (a) of the stripe patterns and a thickness (t) of the transparent film are adjusted so that a critical angle (θ_{c}) may be 20 to 50° (degree) as represented by the following Equation, and an front opening ratio ranges from 50 to 80%, as defined as a ratio of an area of the transparent film, which is not occupied by each of the stripe patterns when viewed from the front of the transparent film, to the entire area of the transparent film:

$${θ}_{c} = arc sin ( {R}_{i} ( sin ( arc tan ( \frac{a}{t} ) ) ) \qquad Equation$$

wherein, Rᵢ represents a refractive index of the transparent film.

In this case, the front opening ratio may range from 55 to 75%.

Also, every pairs of stripe patterns formed parallelly on both surfaces of the film may be completely overlapped with each other when seen from the front of the films.

In addition, the film may have a thickness of 20 μm (micrometer) to 4 mm (millimeter).

In this case, a distance between the stripe patterns may range from 5 to 400 μm (micrometer).

Also, the transparent film may have a visible ray transmittance of 80% or more.

Furthermore, the stripe patterns may have a visible ray transmittance of 40% or less.

### ADVANTAGEOUS EFFECTS

As described above, the filter of a display device according to the present invention may be useful to provide the filter of a display device capable of being manufactured through a simple manufacturing process without any limitation on viewing angles, and also to provide the display device including the filter according to the prevent invention.

### BRIEF DESCRIPTION OF THE DRAWINGS

FIG. 1 is a graph illustrating that a contrast ratio is changed according to the transmittance of a conventional ND filter used for improvement of the contrast ratio, and the illumination intensity of a PDP surface.

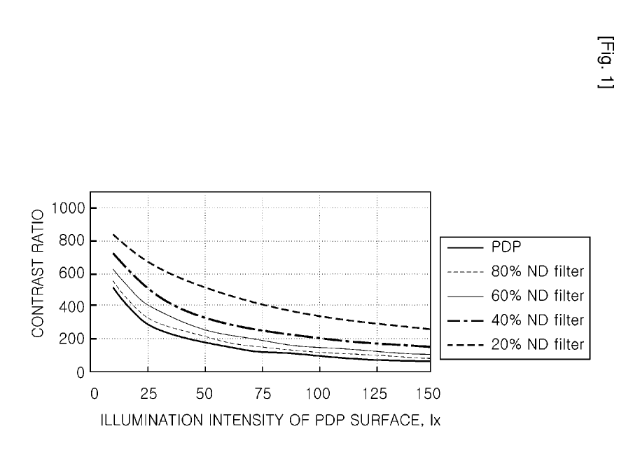

FIG. 2 is a schematic perspective view illustrating a configuration of a filter for a display apparatus as disclosed in Korean Patent Publication No. 10-2006-0080116.

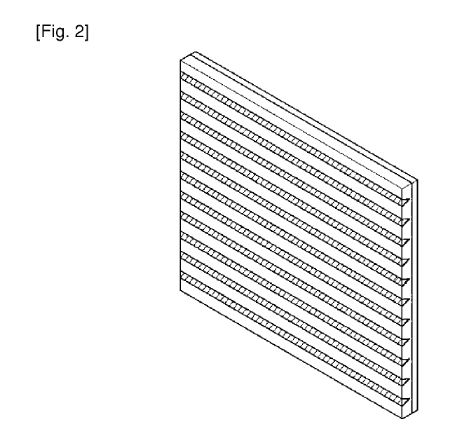

FIG. 3 is a cross-sectional view illustrating that a viewing angle may be deteriorated according to the position of an observer in the use of the filter for a display apparatus as disclosed in Korean Patent Publication No. 10-2006-0080116.

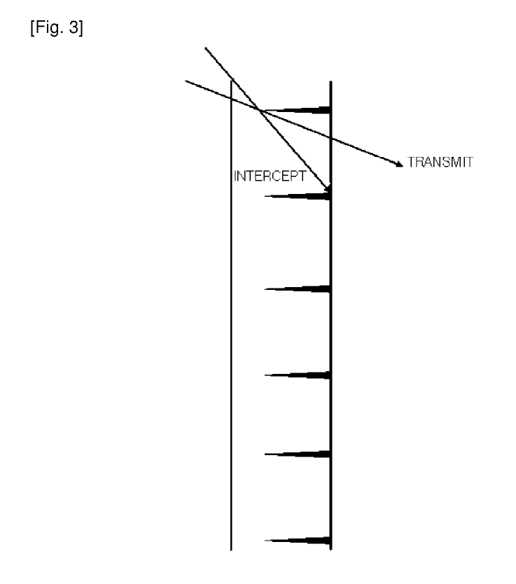

FIG. 4 is a cross-sectional view illustrating a film of a display device according to one exemplary embodiment of the present invention.

FIG. 5 is a schematic view illustrating that an opening ratio is varied according to the path of light.

FIG. 6 is a schematic view illustrating the terms ‘incidence angle’ and ‘release angle’.

FIG. 7 is a schematic view illustrating a path through which an external light reaches the field of vision of an observer.

FIG. 8 is a schematic view illustrating a critical angle (θ_{c}), as one of filter conditions, of the filter according to the present invention.

### BEST MODE FOR CARRYING OUT THE INVENTION

Hereinafter, exemplary embodiments of the present invention will be described in detail with reference to the accompanying drawings.

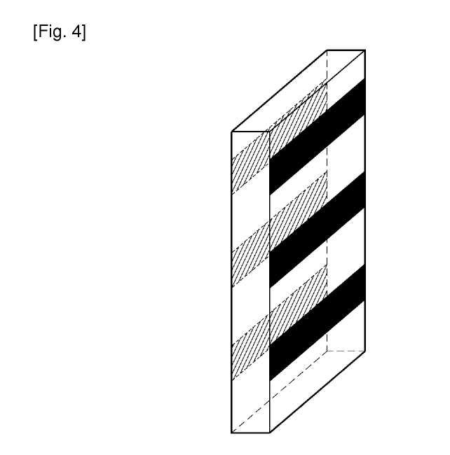

FIG. 4 shows a cross-sectional view of a film of a display device according to the present invention. As shown in FIG. 4, the display device of the present invention includes a transparent film and a number of stripe patterns formed parallel to both surfaces of the transparent film. Here, the term ‘transparent’ generally means

┌light-transmissible┘ in aspect of conventional meanings, and therefore there is on particular limitation on the transmittance. However, a film having a visible ray transmittance of 80% or more may be more suitably used as the transparent film in aspect of the meanings according to the present invention. Also, the stripe patterns that can cut off the light may be used herein without any limitation on their transmittance, but the stripe patterns preferably have a visible ray transmittance of 40% or less so as to cut air the light effectively. In addition, the expression ‘stripe pattern’ used in the present invention means a pattern having a striped shape, but it is considered that there is no limitation that the stripe pattern should be formed in a linear shape, but the stripe pattern is included in the scope of the stripe pattern as described herein when it is formed in a linear shape. That is to say, although the stripe pattern includes periodical or non-periodical rippled/bent shapes that are present when the pattern is seen in a longitudinal direction, it is considered that the pattern is included in the scope of the stripe pattern as described herein if the amplitude or bending of the rippled/bent shapes is not higher than a width of the pattern and a length of the periodical or entire pattern. These modified examples of the present invention do not depart from the functions of the stripe patterns according to the present invention as described later.

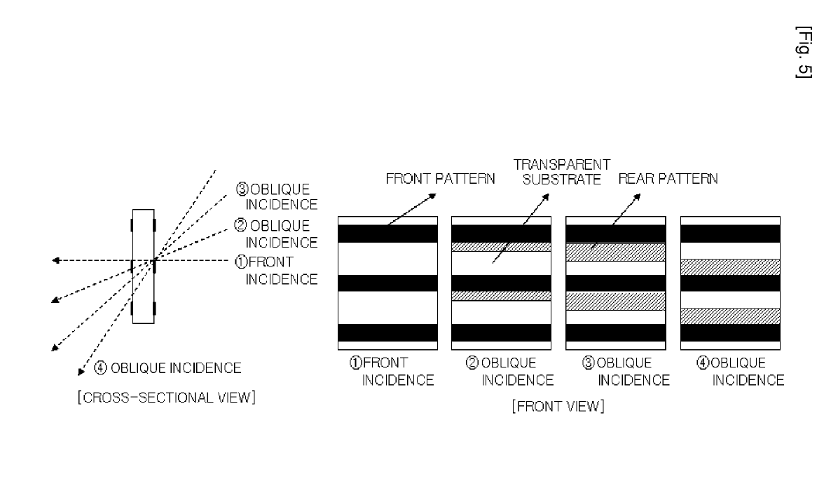

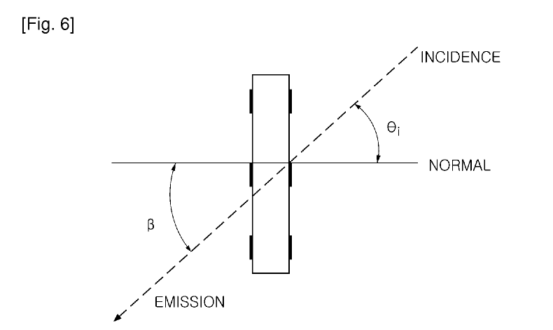

The filter of the present invention as configured thus functions to reduce brightness of a reflective light by cutting off the light that is obliquely incident inward from the outside, as schematically shown in FIG. 5 in addition to the path of the light. A ratio of an area of a film, in which the light is transmitted without interception of the light by each of the stripe patterns, to the entire area of the film is referred to as an opening ratio of a filter. In this case, the opening ratio is decreased as an incidence angle (θᵢ) of the external incident light increase to the critical angle (θ_{c}). That is to say, the external incident light is effectively cut off with the increase in the incidence angle (θᵢ) as shown in FIG. 6. Therefore, as the light is obliquely incident to the critical angle (θ_{c}), the incidence of the light is cut off at a higher level in a direction toward the panel, and then the interception at the critical angle is maintained in an angle range from an angle more than the critical angle (θ_{c}) to a predetermined angle. On the contrary, the light emitted from a surface of the display device generally reaches an observer that stands in the front of the display device, and therefore it is possible to maximize an opening ratio of the light emitted from the front of the display device.

Also, the filter for display apparatus with stripe patterns as disclosed in the Korean Patent Publication No. 10-2006-0080116 has problems that, when the field of vision of an observer is in a too high or low position relative to the display device, most of the light emitted from the display device is cut off, which leads to the narrow viewing angle that reduces brightness of an image. However the filter according to the present invention does not have the above problems. That is to say, the brightness of the light, which is emitted from the display device and reaches the field of vision of an observer, also depends on the opening ratio of stripe patterns formed in both surfaces of a film in the filter. The filter of the present invention has the lower limit value of the opening ratio, and therefore the light equal to or more than a predetermined level may always reach an observer. That is to say, the filter has the maximum opening ratio since two stripe patterns are completely overlapped with each other when the incidence angle (θᵢ) (i.e., a release angle (β) as shown in FIG. 6 is 0° (degree), while the two overlapped stripe patterns are more spread out with the increase in the incidence angle or the release angle when seen in a proceeding direction of the light, which leads to the increase in a region of the cut-off light. However, although the incidence angle or the release angle is so increased, an area rate (opening ratio) of a region occupied by the two stripe patterns should reasonably have their limits, and therefore the opening ratio has its lower limit value. This phenomenon results from the fact that the light may pass through a space between the two stripe patterns as the incidence angle or the release angle are increased since the two stripe patterns are formed parallel to each other while being spaced apart at a predetermined distance from both surfaces of the transparent film.

However, in the case of the film for display apparatus as disclosed in the Korean Patent Publication No. 10-2006-0080116, ┌a ratio of an area through which the light may be passed┘, which corresponds to the opening ratio of the film according to the present invention, continues to be decreased with the increase in the incidence angle or the release angle since the stripe patterns are formed in the form of wedge in the film, and therefore the light is completely cut off.

Characteristics of the filter according to the present invention will be described in detail, as follows.

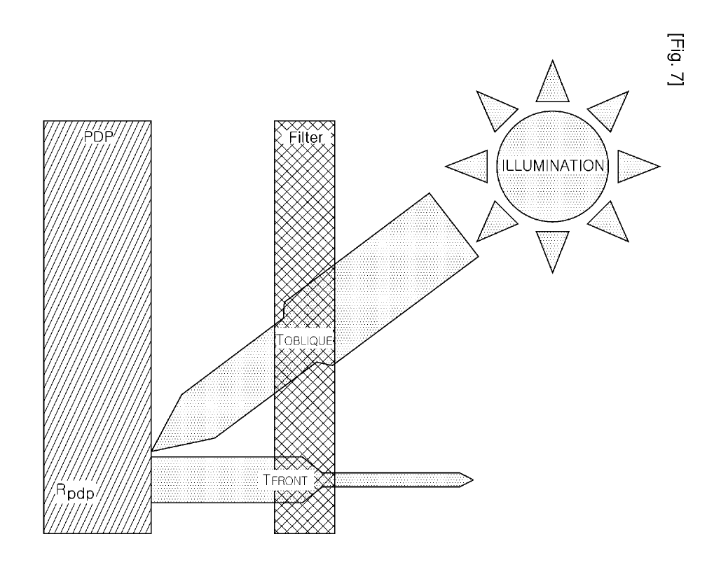

The filter of the display device according to the present invention shows such effect that the transmittance of the incident light is varied according to the angle of the incident light as described above. That is to say, the external light should be passed through light paths as shown in FIG. 7 to have an effect on the contrast ratio when the external light is incident to the surfaces of the display device and then reflected from the surfaces of the display device to reach the filed of vision of an observer. That is to say, when the obliquely incident external light reaches the field of vision of an observer, who is positioned in a vertical direction in relation to the display device, due to the various causes such as scattering or reflection by a phosphor in the display device, the external light is obliquely incident inward to the surfaces of the filter until the external light reaches to the surfaces of the display device. Then, the reflected light proceeds in a vertical direction relative to the filer to reach the field of vision of the observer who is positioned roughly in the front of the display device.

In the meantime, since the opening ratio of the filter of the present invention is varied according to the incident or release angles of the light as described above, the transmittance of the incident light and the transmittance of the release light are not applicable at the same level, as represented by the Equations 7 to 9. That is to say, the transmittances in the incidence and release of the light are commonly used since the transmittances of the light are not significantly varied due to the oblique incidence of the light although the light path of the filter is slightly lengthened since the light is obliquely incident inward as represented by the Equations 7 to 9. However, the transmittances in the incidence and release of the light should be necessarily used differently since the incidence angle and the release angle are significantly varied according to the angle of the light when the light is incident inward and emitted through the filter according to the present invention. Therefore, the Equation 7 needs to be changed into the following Equation 10 in the present invention.

$$contrast ratio ( bright room condition ) = \frac{\begin{matrix}brightness of white light \cdot {T}_{front} + \\ {IL}_{PDP} \cdot {R}_{PDP} \cdot \frac{1}{π} \cdot {T}_{front} \cdot {T}_{oblique θ}\end{matrix}}{\begin{matrix}brightness of black light \cdot {T}_{front +} \\ {IL}_{PDP} \cdot {R}_{PDP} \cdot \frac{1}{π} \cdot {T}_{front} \cdot {T}_{oblique θ}\end{matrix}} \qquad Equation 10$$

In Equation 10, T_{front} represents a transmittance in consideration of the opening ratio when the light is emitted in a direction toward the front of the display device, and T_{obliqueθ} represents a transmittance in consideration of the opening ratio when the light is obliquely incident inward at an angle of θ.

The following Equation 11 may be obtained when the Equation 10 is processed in the same manner as the Equations 8 and 9.

$$contrast ratio ( bright room condition ) = \frac{brightness of white light}{{IL}_{PDP} \cdot {R}_{PDP} \cdot \frac{1}{π}} \cdot \frac{1}{{T}_{oblique θ}} + 1 \qquad Equation 11$$

That is to say, in the use of the filter according to the present invention, the contrast ratio is determined by the transmittance (T_{obliqueθ}) in an oblique direction when the external light is positioned over an angle of θ as seen from Equation 11. In this case, the transmittance in an oblique direction is lower than the transmittance in a front direction, the filter according to the present invention generally has excellent contrast, compared to the conventional filters having isotropic transmittance.

In this case, the transmittance in an oblique direction needs to be calculated differently according to the conditions of external light sources since the transmittance is varied according to the incidence angle of the light as described quantitatively above. However, it is considered that the transmittance of light according to the change of the incidence angle may easily be measured by those skilled in the art to which the present invention belongs.

The contrast ratio at bright room condition calculated from the Equation 11 is roughly inversely proportional to the transmittance (T_{obliqueθ}). In this case, since the conventional filters aril as a ND type filter for improvement of contrast ratio has isotropic properties so that all of the transmittances can be expressed as T_{front}, the contrast ratio of two filters at the brightness room condition are compared to each other, as follows

Contrast ratio of ND filter: Inventive filter at bright room condition≈1/T_{front}:1/T_{obliqueθ} Equation 12

That is to say, when the external light is positioned over an angle of θ based on the normal of a surface of a PDP panel, a nominal contrast ratio of a filter having a front transmittance (T_{front}) of 40% and a transmittance (T_{obliqueθ}) of 28% in an oblique direction (incidence angle θ) to a conventional ND filter having a front transmittance of 40% is in a range of 3.57:2.5. Therefore, the contrast ratio of the filter according to the present invention may be improved by about 43% by controlling the arrangement of the stripe patterns in the filter according to the present invention.

As described above, the filter of the display device according to the present invention may have more preferable physical properties by controlling geometrical shapes such as thickness of a film, width of patterns attached to both surfaces of the film and pattern distance, and variables derived from the geometrical shapes.

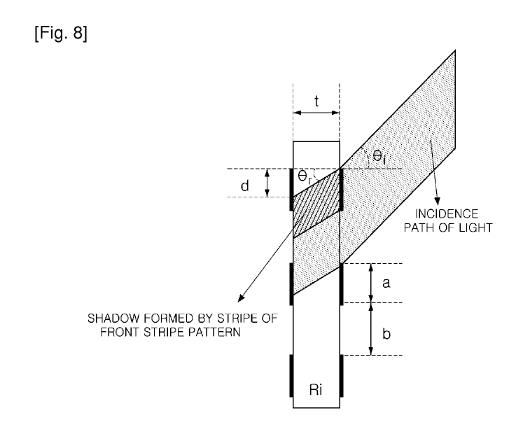

An operation of obtaining a more preferable configuration of the filer according to the present invention will be described in detail with reference to FIG. 8. As described above, for the filter according to the present invention, its opening ratio is decreased with the increase in the incidence angle (θᵢ) of external light, but the opening ratio is not decreased any more when the incidence angle (θᵢ) of the external light reaches a predetermined angle. Therefore, the light that is incident at an angle equal to or more than the above-mentioned angle is cut off with the maximum transmittance that a film with a predetermined shape may have. As a result, the shape of the filter may be changed according to the angle of the incident light.

Therefore, an operation of determining at what angle the external light sources are incident inward is required to determine the shape of the filter since the angel of the incident light highly affects the contrast ratio, wherein the external light sources are profitable to cut off as much as possible.

As shown in FIG. 8, a pair of parallel stripe patterns, which are overlapped with each other when viewed from an incidence direction of the light becomes wider with the increase in the incidence angle (θᵢ) of the external light. As a result, when the two stripe patterns are completely segregated from each other, they have a shape with the widest area to cut off the light in the art, and therefore the contrast ratio reaches the maximum value. When the two stripe patterns start to be completely segregated from each other (i.e., a point of time when d and a have the same distance), the incidence angle (θᵢ) is defined as a critical angle (θ_{c}).

As defined in FIG. 8, the following relation may be obtained when it is assumed that a refractive index of a film is Rᵢ, a width of a stripe pattern a, a distance between two adjacent stripe patterns is b, d is a width of a region in which a shadows of a stripe pattern disposed in the rear of the film is not formed by the incident external light on a stripe pattern disposed in the front of the film when the external light is incident inward at an angle of θᵢ, and a thickness of a film is t.

$$\frac{d}{t} = tan ( arc sin ( \frac{sin {θ}_{i}}{{R}_{i}} ) ) \qquad Equation 13$$

The Equation 13 is obtained by calculating an angle of θᵣ (an angle of light that is refracted and incident inward in a film) of FIG. 8 from the Snell's Law and applying a reversed notion to the relation of θᵣ and d/t. As described above, an angle at the point of time when the d and a has the same value is referred to as a critical angle (θ_{c}), and therefore the following Equation 14 may be obtained by substituting ‘a’ instead of ‘d’ of Equation 13 and ‘θ_{c}’ instead of ‘θᵢ’ of Equation 13.

$$\frac{a}{t} = tan ( arc sin ( \frac{sin {θ}_{c}}{{R}_{i}} ) ) \qquad Equation 14$$

As a result, θ_{c} may be calculated by the following Equation 15 expressing a reversed function of the Equation 14.

$${θ}_{c} = arc sin ( {R}_{i} ( sin ( arc tan ( \frac{a}{t} ) ) ) \qquad Equation 15$$

As seen intuitionally from the Equations and the definition of critical angle (θ_{c}), when the critical angle (θ_{c}) of the film is increased, the light may be incident inward to and reflected from the film as much as the increased critical angle (θ_{c}), and therefore it may also be impossible to obtain a desired effect due to the diminished contrast ratio. Therefore, it is necessary to control the critical angle (θ_{c}) to an angle level equal to or less than a predetermined angle. From the research results by the present inventors, it is seen that the critical angle (θ_{c}) is necessarily controlled to an angle of 50° (degree) or less in consideration of general external lighting conditions. However, when the critical angle is decreased on the contrary to the above case, the transmittance is highly changed even by the changes in small incidence angle, which may give the uneasiness to observers (viewers). Accordingly, the critical angle is preferably more than 20° (degree).

An opening ratio is another important factor that determines the performances of the filer for a display device according to the present invention. The opening ratio is defined as a ratio of an area of the transparent film, which is not occupied by each of the stripe patterns, to the entire area of the transparent film, as described above. Since the opening ratio is varied according to the incidence direction of the light, the opening ratio obtained when the light is incident inward to the front of a film is especially referred to as ┌front opening ratio┘ (i.e., an area ratio et a stripe pattern-free transparent region to the entire area (a film when viewed from the front of the film)

The front opening ratio is one important factor that determines the front transmittance of light emitted from PDP, and therefore the brightness of a screen may be undesirably reduced by the light emitted from the PDP when the front opening ratio is too low. On the contrary, the contrast ratio is not improved since it is difficult to cut off the obliquely incident external light when the front opening ratio is too high. Therefore, the front opening ratio is preferably in a range of 50 to 80%, and more preferably in a range of 55 to 75%, in consideration of the addition of a near infrared ray film (absorbance: about 20%), an electromagnetic wave shielding film (absorbance: about 10%) and the like in the conventional PDP display devices.

Also, the filter for a display device according to the present invention may be used when it may satisfy one of the conditions such as the critical angle and front opening ratio, but the filter that satisfies both of the critical angle and front opening ratio is more preferred.

In addition to the conditions, a thickness of a film is one of conditions for obtaining more desirable effects in the present invention. When the thickness et the film is too thick, a width of its stripe patterns should be increased to meet the opening ratio and the critical angle. In this case, the stripe patterns may be undesirably, observed with the naked eye. On the contrary, when the thickness of the film is too thin, it may be difficult to manufacture and store a film. Therefore, the thickness of the film may need to be maintained to a suitable thickness range. According to the research results by the present inventors, the thickness of the film is preferably in a range of 20 μm (micrometer) to 4 mm (millimeter), and more preferably in a range of 20 to 200 μm (micrometer).

Also, when the opening ratio and the thickness of a film are satisfied as defined in the present invention, a distance between the stripe patterns is more preferably in a range of 5 to 400 μm (micrometer).

In addition, the stripe patterns in the filter of the present invention that meets the above-mentioned conditions are preferably arranged parallel to each other in both surfaces of the film. Here, to arrange stripe patterns parallel to each other means that only a pattern formed in the front of a film is observed but a pattern formed in the rear of the film is not observed since it is overlapped with the pattern formed in the front of a film, when a filter is viewed from the front of the film. However, the term ┌overlapped┘ as used herein is used in aspect of the industrial meanings, and therefore it is easily understood that the term ┌overlapped┘ is used as a concept including some errors appearing in the manufacturing process, as apparent to those skilled in the art.

Furthermore, for the stripe pattern formed on the same surface out of the front and rear of each film, all stripes are also preferably formed parallel to each other. Also, the stripe patterns are preferably formed with the same width and distance as it is possible. The term ┌parallel┘ or ┌same┘ as used herein is also as described above in aspect of the industrial meanings.

The filter for a display device according to the present invention has stripe patterns that are formed parallel to each other in both surfaces of the transparent film as described above. Here, the stripe patterns may be produced according to a method for forming a stripe pattern to meet the desirable conditions of the present invention. It is understood that the stripe patterns may be easily formed using various conventional methods such as sputtering, printing, photolithographic processes, which may be suitable selected according to the conditions of the film, as apparent to those skilled in the art to which the present invention belongs.

### MODE FOR THE INVENTION

Hereinafter, exemplary embodiments of the present invention will now be described in detail with reference to the accompanying drawings. However, it is considered that the description proposed herein is just a preferable example for the purpose of illustrations only, not intended to limit the scope of the invention, so it should be understood that other equivalents and modifications could be made thereto without departing from the spirit and scope of the invention. Therefore, it is understood that the spirit and scope of the invention are derived from the claims of the present invention.

### EXAMPLES

### Effects on Improvement of Contrast ratio according to Change in Critical Angle

A contrast improvement effect, which is expected in producing a filter for a display device, was compared and calculated according to the conditions as listed in the following Table 1. Transmittance of a film used in the filter was set to a transmittance level of 90%, and transmittances of its front/rear stripe patterns were all set to a transmittance level of 0%. Also, an front opening ratio, a thickness and a refractive index (Rᵢ) of the film were set to 70%, 75μm and 1.6, respectively. For a PDP display device, brightnesses of a white light and a black light were set to a brightness level of 575.3 cd/m² and 0.9 cd/m², respectively, and an illumination intensity in a PDP surface by lightening was set to 2001×, and a reflectance of the PDP panel was set to 29%. To confirm effects of the filter for a display device in use environments or their similar use environments, it was assumed that the filter for display device is used with it being stacked with an electromagnetic wave shielding film having a light absorbance of 10%, a near infrared ray absorbing film having a light absorbance of 20%, and a color layer having a light absorbance 10%. Filters as listed in the fallowing Table 1 were used to calculate values of their improved contrast ratio according to the conditions of the Equation 10. Here, the filters of Inventive example prepared according more preferable conditions of the present invention, the filter of Comparative example 1 prepared according to conditions except for the more preferable conditions of the present invention, and the conventional ND filter were used as the filters, and the results were also listed in the following Table 1.

As listed in the following Table 1, it is seen that the transmittance of the ND filter is slightly changed with the changes in the incidence angle of the ND filter, and also revealed that the transmittance of the ND filter is increased with the increase of the optical incidence angle of the ND filter. This results from the fact that a light path in the film is lengthened with the increase in the incidence angle, thereby diminishing the transmittance of the light. The transmittance, incidence angle and refractive index of the films were measured at the front of the films in consideration of the above results. In this case, when it is assumed that the transmittance of the film is Tₒ, the incidence angle of the film is θ₁, and the refractive index of the film is Rᵢ, the changes in the transmittance of the film by the incidence angle may be expressed by T of the following Equation 16.

$$T = {10}^{( log {T}_{0} \cdot {( cos ( arc sin ( \frac{sin {θ}_{1}}{{R}_{i}} ) ) )}^{- 1} )} \qquad Equation 16$$

Therefore, the transmittances of the ND film, and the electromagnetic wave shielding film, the near infrared ray absorbing film and the color layer, all of which are attached to the filter for a display device, were calculated in the same manner as described above, by using the transmittance (T) according to the Equation 16. The absorbance can be calculated from the relation (absorbance=1−T).

TABLE 1

| | | Inventive | Inventive | Inventive | Comparative | Comparative |
|---|---|---|---|---|---|---|
| | conditions | example 1 | example 2 | example 3 | example 1 | example 2 |
| Film shape | Critical angle (θ_{c}) | 20 | 30 | 40 | 60 | ND filter |
| | Stripe width (μm) | 16.4 | 24.7 | 32.9 | 54.4 | |
| | Distance between | 38.3 | 57.6 | 76.8 | 127.0 | |
| | stripes (μm) | | | | | |
| Transmittance | Front | 41 | 41 | 41 | 41 | 41 |
| (%) by | 10° Incidence | 32 | 35 | 36 | 38 | 41 |
| incidence | 20° Incidence | 23 | 29 | 32 | 34 | 40 |
| angle of light | 30° Incidence | 23 | 23 | 27 | 31 | 39 |
| | 40° Incidence | 22 | 22 | 22 | 28 | 37 |
| Contrast ratio | Front | 69 | 69 | 69 | 69 | 69 |
| by incidence | 10° Incidence | 85 | 79 | 76 | 74 | 69 |
| angle of | 20° Incidence | 112 | 93 | 86 | 80 | 71 |
| lighting | 30° Incidence | 114 | 114 | 99 | 88 | 72 |
| | 40° Incidence | 116 | 116 | 116 | 97 | 75 |

As seen from the results of Table 1, it was revealed that, when the shapes of the films are controlled according to the critical angle proposed in the present invention, the contrast continues to be improved until an incidence angle of a power source increase to the critical angle. That is to say, for the film whose critical angle is set to 20° (degree), it was revealed that the contrast ratio is suddenly increased until an incidence angle of external lighting increases to 20°, and then the contrast ratio is maintained to a constant level after the incidence angle of external lighting reaches 20°. For the film whose critical angle is set to 40° (degree), it was seen that its contrast ratio is continuously increased until the incidence angle also increases to 40°. In particular, it was seen that the contrast ratio is significantly improved in most of the expected optical incidence angles. That is to say, the external light is hardly installed in the front of the display device, and therefore it was revealed that the contrast ratio is conspicuously improved except that the external light is installed in the front of the display device. However, the filter of Comparative example 1 has a critical angle of 60° which is higher than the critical angle as defined in the present invention. In this case, it was revealed that the filter of Comparative example 1 has more excellent contrast ratio than the conventional ND filter, but does not have an improved contrast ratio, compared to the contrast ratio of the filters according to the Inventive examples of the present invention. Furthermore, the contrast improvement effect of the conventional ND filter was measured for comparison, and the results were listed as described in Comparative example 2. From the results, it was seen that the contrast ratio is hardly improved according to the incidence angle.

### Effect on Improvement of Contrast Ratio According to Change in Front Opening Ratio

A contrast improvement effect, which is expected in producing a filter for a display device, was compared and calculated according to the conditions as listed in the following Table 2. Transmittance of a film used in the filter was set to a transmittance level of 90%, and transmittances of its stripe patterns were all set to a transmittance level of 0%. For a PDP display device, brightnesses of a white light and a black light were set to a brightness level of 575.3 cd/m² and 0.9 cd/m², respectively. Also, an illumination intensity in a PDP surface by lightening was set to 2001×, and a reflectance of the PDP panel was set to 29%. Also, a critical angle of the film was set to 40°, a thickness was set to 75 μm, and a refractive index (Rᵢ) was set to 1.6. To confirm effects of the filter for a display device in use environments or their similar use environments, it was assumed that the filter for display device is used with it being stacked with an electromagnetic wave shielding film having a light absorbance of 10%, a near infrared ray absorbing film having a light absorbance of 20%, and a color layer having a light absorbance 10%. filters as listed in the following Table 2 were used to calculate values of their improved contrast ratio according to the conditions of the Equation 10, and their calculated results were listed in the following Table 2.

TABLE 2

| | | Comparative | Inventive | Inventive | Inventive | Inventive | Comparative |
|---|---|---|---|---|---|---|---|
| | conditions | example 3 | example 4 | example 5 | example 6 | example 7 | example 4 |
| Film shape | Front Opening | 40 | 50 | 60 | 70 | 80 | 90 |
| | ratio (%) | | | | | | |
| | Stripe width (μm) | 32.9 | 32.9 | 32.9 | 32.9 | 32.9 | 32.9 |
| | Distance | 21.9 | 32.9 | 49.4 | 76.8 | 131.6 | 296.1 |
| | between | | | | | | |
| | stripes (μm) | | | | | | |
| Transmittance | Front | 23 | 29 | 35 | 41 | 47 | 52 |
| (%) by | 10° Incidence | 15 | 22 | 29 | 36 | 44 | 51 |
| incidence | 20° Incidence | 6 | 14 | 23 | 32 | 40 | 49 |
| angle of light | 30° Incidence | 0 | 7 | 17 | 27 | 37 | 47 |
| | 40° Incidence | 0 | 0 | 11 | 22 | 33 | 45 |
| Contrast ratio | Front | 111 | 92 | 79 | 69 | 61 | 55 |
| by incidence | 10° | 161 | 117 | 93 | 76 | 65 | 57 |
| angle of | 20° | 292 | 162 | 112 | 86 | 70 | 59 |
| lighting | 30° | 639 | 261 | 143 | 99 | 75 | 61 |
| | 40° | 639 | 639 | 195 | 116 | 82 | 64 |

As seen from the results of Table 2, it was revealed that, when the filter has a low front opening ratio (Comparative example 3), the increase of contrast ratio is large and the maximum contrast ratio is also very high when the incident angle reached at the critical angle, but the front transmittance is low due to the low opening ratio. On the contrary, it was seen that, when the filter has a high opening ratio (Comparative example 4), the contrast ratio is slightly increased with the increase in the incidence angle of the light source and the maximum contrast ratio is also low, which make it impossible to obtain a filter having desired performances.

As seen from the results of Table 2, it was revealed that, when the shape of the film is controlled to have an opening ratio proposed in the present invention, the contrast ratio is improved as the incidence angle of the light source increases, i.e., as the external light is obliquely incident inward. In particular, it was seen that the contrast ratio is significantly improved in most of the expected optical incidence angles. That is to say, the external light is hardly installed in the front of the display device, and therefore it was revealed that the contrast ratio is conspicuously improved except that the external light is installed in the front of the display device.

### Effect on Improvement of Contrast Ratio According to Change in Transmittance of Stripe Patterns

A contrast improvement effect, which is expected in producing a filter for a display device, was compared and calculated according to the conditions as listed in the following. Table 3. Transmittance of a film used in the filter was set to a transmittance level of 90%. Also, an opening ratio, a critical angle, a thickness and a refractive index (Rᵢ) of the film were set to 70%, 40° (degree), 75 μm (micrometer) and 1.6, respectively. For a PDP display device, brightnesses of a white light and a black light were set to a brightness level of 575.3 cd/m² and 0.9 cd/m², respectively, and an illumination intensity in a PDP surface by lightening was set to 2001 ×, and a reflectance of the PDP panel was set to 29%. To confirm effects of the filter for a display device in use environments or their similar use environments, it was assumed that the filter for display device is used with it being stacked with an electromagnetic wave shielding film having a light absorbance of 10%, a near infrared ray absorbing film having a light absorbance of 20%, and a color layer having a light absorbance 10%. Therefore, the results were also listed in the following Table 3.

TABLE 3

| | | | | Inventive | Inventive | |
|---|---|---|---|---|---|---|
| | | Inventive | Inventive | example | example | Comparative |
| | Conditions | example 8 | example 9 | 10 | 11 | example 5 |
| Film shape | Transmittance (%) | 0 | 10 | 20 | 30 | 50 |
| | of front/rear stripe | | | | | |
| | patterns | | | | | |
| | Stripe width (μm) | 32.9 | 32.9 | 32.9 | 32.9 | 32.9 |
| | Distance between | 76.8 | 76.8 | 76.8 | 76.8 | 76.8 |
| | stripes (μm) | | | | | |
| Transmittance | Front | 41 | 41 | 42 | 42 | 45 |
| (%) by | 10° Incidence | 36 | 37 | 39 | 40 | 44 |
| incidence angle | 20° Incidence | 32 | 34 | 36 | 38 | 43 |
| of light | 30° Incidence | 27 | 26 | 29 | 32 | 39 |
| | 40° Incidence | 22 | 26 | 29 | 32 | 39 |
| Contrast ratio | Front | 69 | 69 | 68 | 67 | 63 |
| by incidence | 10° Incidence | 76 | 75 | 73 | 70 | 65 |
| angle of | 20° Incidence | 86 | 82 | 78 | 74 | 67 |
| lighting | 30° Incidence | 99 | 91 | 85 | 79 | 69 |
| | 40° Incidence | 116 | 103 | 93 | 85 | 72 |

As seen from Table 3, it was revealed that, when the incidence angle of the external light is 0° (degree), there is no difference in the contrast ratio of the filter since the front/rear stripe patterns are overlapped with each other, but the front and rear stripe patterns should function to cut off the incident light with an increasing incidence angle of the filter. In this case, it is difficult to obtain a filter having a desired contrast improvement effect since the high transmittance of the stripe patterns results in the deterioration in the shielding effect of the light to be cut off, as described in Comparative example 5.

Therefore, it was seen that the contrast ratio is increasingly improved as the incidence angle of the external light is increased, that is, as the external light is obliquely incident inward. In particular, it was seen that the contrast ratio is significantly improved in most of the expected optical incidence angles. That is to say, the external light is hardly installed in the front of the display device, and therefore it was revealed that the contrast ratio is conspicuously improved except that the external light is installed in the front of the display device. However, it was seen that the filter of Comparative example 5 in which the stripe patterns have a transmittance of 50% has a lower contrast improvement effect than the filters of Inventive examples. Therefore, it was seen that both of the front and rear stripe pattern maintain their transmittance to 40% or less.

### Comparison of Calculated Data and Experimental Data—ND Filter

The performances of the filter were confirmed under the desirable conditions according to the above-mentioned exemplary embodiments of the present invention. From the calculated results of the above-mentioned exemplary embodiments, it was not however confirmed whether the display filter of the present invention actually has the same or substantially same behaviors. In consideration of the facts, the present inventors manufactured and measured display filters according to the conditions as listed in the following Table 4. Then, the resulting performances of the display filters were compared to the calculated results obtained from Equation 7 under the same conditions. The results of Table 4 were firstly obtained from the ND filters used for the Comparative examples.

As the conditions except for the contents as listed in Table 4, for the PDP display device, a brightness of a white light was set to a brightness level of 575.3 cd/m ², a brightness of a black light was set to a brightness level of 0.9 cd/m ². Also, an illumination intensity of a PDP surface by the lightening was set to an illumination level of 2001×, and a reflectance of a PDP panel was set to a reflectance level of 29%.

TABLE 4

| | | | ND | ND | ND |
|---|---|---|---|---|---|
| | | ND filter 1 | filter 2 | filter 3 | filter 4 |
| Experimental | Transmittance | 74.3% | 57.8% | 45.1% | 36.0% |
| value | (Tfilter) | | | | |
| | Contrast ratio | 39.0 | 48.8 | 60.8 | 74.9 |
| Calculated | Contrast ratio | 38.9 | 48.9 | 61.0 | 74.3 |
| value | | | | | |

As seen from the context of Table 4, it was revealed that the transmittance of the ND filter is fixed, the theoretical contrast ratio is very similar to the experimental contrast ratio, which indicates that the conditions used for the calculation exactly coincide with the actual conditions of the filter.

### Comparison of Calculated Data and Experimental Data—Inventive Filter

On the basis of the same reasons as the comparison of the results of the measured ND filters, the filter having stripe patterns formed therein was measured for contrast ratio, and the experimental contrast ratio according to Equation 10 was compared to the theoretical contrast ratio, as proposed in the present invention.

The measurement conditions were listed in the following Table 5. In addition to the conditions as listed in the following Table 5, for the PDP display device, a brightness of a white light was set to a brightness level of 575.3 cd/m ², and a brightness of a black light was set to a brightness level of 0.9 cd/m ². Also, an illumination intensity of a PDP surface by the lightening was set to an illumination level of 2001×, and a reflectance of a PDP panel was set to a reflectance level of 29%. As the filter, a filter, obtained by forming a film (with a line width of 33 μm and a distance of 73/cm: front opening ratio of 69%) on a film (with a thickness of 75 μm (micrometer), an optical transmittance of 90% and a refractive index of 1.6) using a photolithographic process. The critical angle of the filter was 40°. However, the experimental results showed that the transmittance and the contrast ratio were measured to be significant at the incidence angles of 0, 10, 20, 30 and 40°, but the transmittance and the contrast ratio were measured at an incidence angle of 40° (degree) since their measurements are not easy at various incidence angles.

TABLE 5

| | | Calculated | Experimental |
|---|---|---|---|
| | Conditions | value | value |
| Design value | a | 33.0 | 33.0 |
| | b | 73.0 | 73.0 |
| | Transmittance of front | 0% | 0% |
| | stripe pattern | | |
| | Transmittance of rear | 10% | 10% |
| | stripe pattern | | |
| Transmittance (%) | Front | 62% | 59% |
| by incidence angle | 10° Incidence | 56% | 54% |
| of light | 20° Incidence | 50% | 47% |
| | 30° Incidence | 43% | 40% |
| | 40° Incidence | 37% | 35% |
| Contrast ratio by | 0° Incidence | 18.2 | |
| incidence angle of | 10° Incidence | 19.9 | |
| lightening | 20° Incidence | 22.1 | |
| | 30° Incidence | 24.9 | |
| | 40° Incidence | 28.4 | 29.6 |

From the results of the Table 5, it was revealed that, when the filter having stripe patterns was used herein, the theoretical contrast ratio also exactly coincide with the experimental contrast ratio of the actually manufactured display filter. From the calculated results in the above-mentioned Tables 1 to 3, it was revealed that the filters of Inventive examples prepared according to more preferable conditions of the present . invention have more excellent performances than the filter prepared according to conditions except for the more preferable conditions of the present invention when they are compared and analyzed to each other.

1. A filter of a display device, comprising:
a transparent film; and
a plurality of stripe patterns formed parallelly on both surfaces of the transparent film,
wherein a width (a) of the stripe patterns and a thickness (t) of the transparent film are adjusted so that a critical angle (θ_{c}) may be 20 to 50°, as represented by the following Equation:
$${θ}_{c} = arc sin ( {R}_{i} ( sin ( arc tan ( \frac{a}{t} ) ) ) \qquad Equation$$
wherein, Rᵢ represents a refractive index of the transparent film.

2. A filter of a display device, comprising:
a transparent film; and
a plurality of stripe patterns formed parallelly on both surfaces of the transparent film,
wherein a front opening ratio ranges from 50 to 80%, as defined as a ratio of an area of the transparent film, which is not occupied by each of the stripe patterns when viewed from the front of the transparent film, to the entire area of the transparent film.

3. The filter of claim 2, where the front opening ratio ranges from 55 to 75%.

4. A filter of a display device, comprising:
a transparent film; and
a plurality of stripe patterns formed parallelly on both surfaces of the transparent film,
wherein a width (a) of the stripe patterns and a thickness (t) of the transparent film are adjusted so that a critical angle (θ_{c}) may be 20 to 50° as represented by the following Equation, and
wherein an front opening ratio ranges from 50 to 80%, as defined as a ratio of an area of the transparent film, which is not occupied by each of the stripe patterns when viewed from the front of the transparent film, to the entire area of the transparent film:
$${θ}_{c} = arc sin ( {R}_{i} ( sin ( arc tan ( \frac{a}{t} ) ) ) \qquad Equation$$
wherein, Rᵢ represents a refractive index of the transparent film.

5. The filter of claim 4, wherein the front opening ratio ranges from 55 to 75%.

6. The filter of claim 1, wherein every pairs of stripe patterns formed parallelly on both surfaces of the film are completely overlapped with each other when seen from the front of the films.

7. The filter of claim 1, wherein the film has a thickness of 20 μm micrometer) to 4 mm (millimeter).

8. The filter of claim 7, wherein a distance between the stripe patterns ranges from 5 to 400 μm.

9. The filter of claim 1, wherein the transparent film has a visible ray transmittance of 80% or more.

10. The filter of claim 1, wherein the stripe patterns have a visible ray transmittance of 40% or less.

11. The filter of claim 2, wherein every pairs of stripe patterns formed parallelly on both surfaces of the film are completely overlapped with each other when seen from the front of the films.

12. The filter of claim 2, wherein the film has a thickness of 20 μm (micrometer) to 4 mm (millimeter).

13. The filter of claim 12, wherein a distance between the stripe patterns ranges from 5 to 400 μm.

14. The filter of claim 2, wherein the transparent film has a visible ray transmittance of 80% or more.

15. The filter of claim 2, wherein the stripe patterns have a visible ray transmittance of 40% or less.

16. The filter of claim 4, wherein every pairs of stripe patterns formed parallelly on both surfaces of the film are completely overlapped with each other when seen from the front of the films.

17. The filter of claim 4, wherein the film has a thickness of 20 μm (micrometer) to 4 mm (millimeter).

18. The filter of claim 17, wherein a distance between the stripe patterns ranges from 5 to 400 μm.

19. The filter of claim 4, wherein the transparent film has a visible ray transmittance of 80% or more.

20. The filter of claim 4, wherein the stripe patterns have a visible ray transmittance of 40% or less.
